(19) United States
(12) Patent Application Publication
(10) Pub. No.: US 2002/0190516 A1
(43) Pub. Date: Dec. 19, 2002

(54) Structural part for chassis or body of a motor vehicle

(75) Inventors: Thomas Henksmeier, Lippstadt (DE); Christian Theissing, Halverde (DE)

Correspondence Address: Henry M. Feiereisen, Suite 3220, 350 Fifth Avenue, New York, NY, 10118, US

(73) Assignee: BENTELER AUTOMOBILTECHNIK GMBH & CO. KG, Paderborn (DE)

(21) Appl. No.: 10/126,473

(22) Filed: Apr. 19, 2002

(30) Foreign Application Priority Data
Apr. 27, 2001 (DE) 101 20 934.7

(51) Int. Cl. B62D 21/12

(52) U.S. Cl. 280/785

(57) ABSTRACT

A structural chassis or body part, in particular axle support, includes at least two steel components having different strengths, with one of the components being heat-treated. The components have different strengths, whereby the heat-treated component can have a yield strength of about 900 MPa. The components may each be made of separate parts, with the separate parts as well as the components themselves being joined together, for example by welding.

### CROSS-REFERENCES TO RELATED APPLICATIONS

This application claims the priority of German Patent Application Serial No. 101 20 934.7, filed Apr. 27, 2001, pursuant to 35 U.S.C. 119(a)-(d), the subject matter of which is incorporated herein by reference.

### BACKGROUND OF THE INVENTION

The present invention relates to a structural part for chassis or body of a motor vehicle.

Structural chassis parts, involved here, include, i.a., front axle supports or rear axle supports, as well as door impact carriers, bumpers, frame side rails or frame columns, and are exposed during operation of the motor vehicle to high static and dynamic loads. Production of such structural parts is predominantly carried out to date by using non-heat treated or low-alloy steels. The use of these steels represents a compromise between deformation capability and yield strength of the materials, as an increase in yield strength normally reduces the deformation capability of the material and decreases a remaining residual fracture strain after cold forming. Steels of higher strength can be processed oftentimes only through a hot forming process in order to produce structural parts useful for chassis or body of a motor vehicle.

Various structural chassis or body parts are typically manufactured at oversize to dimension the wall thickness in accordance with a greatest load to be expected. This approach is applied, even though areas exposed to smaller loads may not require such maximum wall thickness. For that reason, another approach proposes the use of so-called tailored blanks, which involve a joining of metal sheets of different strength and/or different sheet thickness through welding. Structural chassis or body parts manufactured in this fashion have zones of varying thickness, under observation of necessary safety factors, to suit different loads or tensions during operation of the motor vehicle. The production of tailored blanks is, however, complex, and moreover the forming process is problematic in view of the jumps in sheet thickness.

It would therefore be desirable and advantageous to provide an improved structural chassis or body part which obviates prior art shortcomings and which is so constructed as to more efficiently suit loads that expose different areas of the structural part, while still being reliable in operation.

### SUMMARY OF THE INVENTION

According to one aspect of the present invention, a structural chassis or body part, in particular axle support, includes at least two steel components of different strengths, with one of the components being heat-treated.

The present invention resolves prior art problems by making the structural part from several components which have different strength to suit varying loads encountered during operation, whereby those components which are situated in high-load areas are heat-treated. The components are made separately from one another with the desired strengths, whereby some of the components are heat-treated. The term “heat-treating” as used herein refers to any tempering process, involving the heating and cooling of a steel material in the solid state to provide certain strength properties. It will also be understood by persons skilled in the art that the terms “heat-treating” and “tempering” are used synonymous in the disclosure. For example, the heat-treating process may be implemented in a continuous furnace, followed by a quenching process. The components, which are combined together, may be tempered or heat-treated to a different degree. Currently preferred is a combination of heat-treated components with non-heat treated components.

According to another feature of the present invention, the heat-treated components may have a yield strength between 850 MPa and 950 MPa. As a consequence, components of highest strength are employed in the most critical load zones and joined with remaining components to form a complete unitary structure. Components for areas exposed to smaller loads may be made of normal high-grade steel or constructional steel.

Structural chassis or body parts according to the present invention can be made at lower overall weight at reduced item costs and manufacturing costs as well as lower material use.

The heat-treated component may be made of two or more parts which are combined to a unitary structure which is then subjected to a heat treatment. In this way, smaller structures can be tempered. There is no need to heat-treat the entire structural chassis or body part so that investment and operating costs for large-scale heat-treatment plants can be saved. Moreover, heat distortion of the finished structural chassis or body part can be avoided.

A structural chassis or body part according to the present invention exhibits also a good dynamo-elastic behavior because only those components that are exposed to great loads, i.e. critical zones, are heat-treated to exhibit the required strength. The remaining components are, on the other hand, softer and show a more elastic vibration behavior.

According to another feature of the present invention, the components are connected together through a jointing process. Since steel parts are involved here, the application of a welding process is appropriate. Of course, any other force-fitting or form-fitting jointing techniques, such as gluing or shrinkage, may be used as well and should be covered by this disclosure.

According to another feature of the present invention, the components may interlock in a connection zone and jointed together. Also this type of connection can suitably be realized through welding.

In accordance with the present invention, a structural chassis or body part can be made with greater strength in high-load zones, thereby increasing the flexibility when configuring the structural part, e.g., axle support. Moreover, the crash behavior can be enhanced. As the construction can be more compact, the available installation space can be better utilized. Weight and costs can be saved by optionally reducing the wall thickness in zones that are exposed to smaller loads. Costs can further be reduced to make some components of the structural part of non-heat treated steels, which is cheaper. Manufacturing structural chassis or body parts includes standard processes such as heat-treatment, hardening, shaping, thereby ensuring a high process safety.

Examples of structural chassis or body parts for use in a motor vehicle and constructed in accordance with the present invention include front or rear axle supports, multilink suspensions or twist-beam axles, door impact carriers, side impact carriers, bumpers, frame side rails or frame columns, such as A column, B column, C column, D column.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a perspective illustration of an exemplified front axle having incorporated therein the present invention; and

FIG. 2 is a cutaway view, on an enlarged scale, showing details of a junction area of the front axle.

### DETAILED DESCRIPTION OF PREFERRED EMBODIMENTS

Throughout all the Figures, same or corresponding elements are generally indicated by same reference numerals.

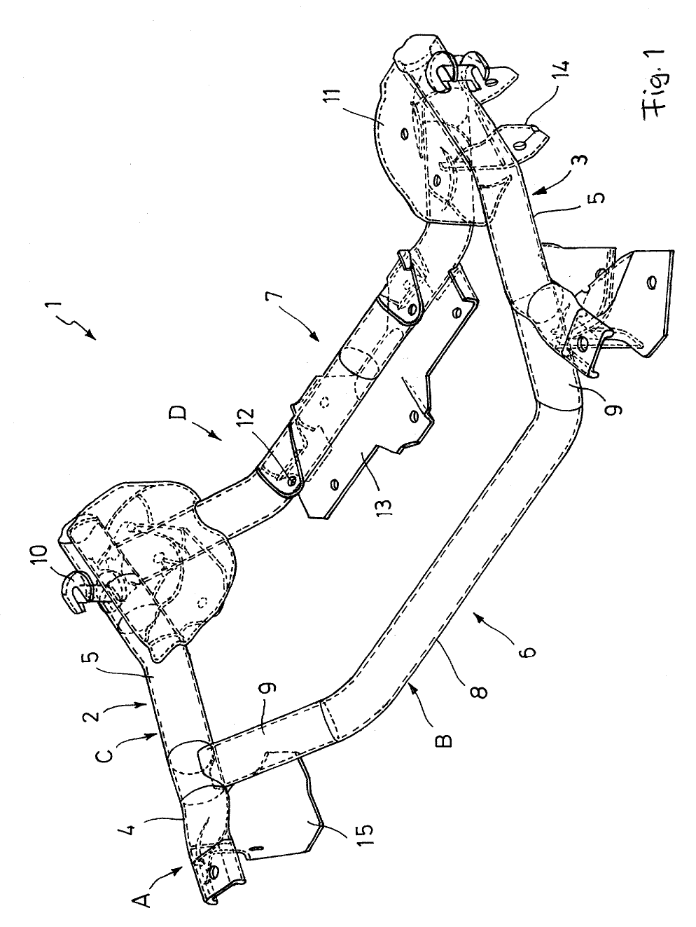

Turning now to the drawing, and in particular to FIG. 1, there is shown a perspective illustration of an exemplified front axle having incorporated therein the present invention. The front axle has an axle support 1 in the form of a frame construction which includes substantially a front side carrier 2 in the form of a tube 4, a rear side carrier 3 in the form of a tube 5, a front cross member 6 and a rear cross member 7, with the cross members 6, 7 interconnecting the side carriers 2, 3. The front cross member 6 is comprised of a central tube 8 having opposite ends connected to outer tubes 9, respectively.

The axle support 1 provides a solid mount for various systems, e.g. attachment of a body shell at the back, designated by reference numeral 10, attachment of the engine mount console 11, bracket 12 for the steering gear, a multi-functional sheet metal plate 13 in mid-section of the rear cross member 7, and a bracket 14 for restraining the rear cross member 7.

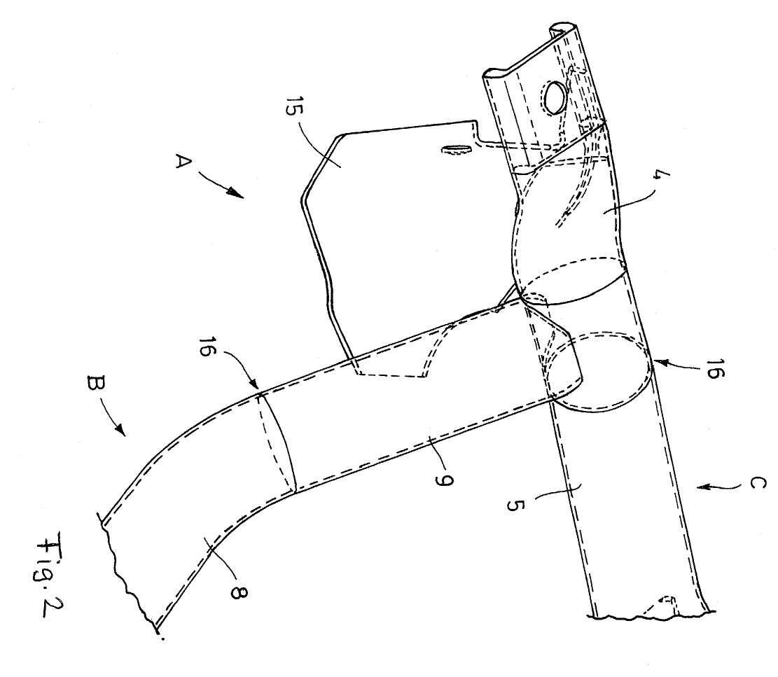

The axle support 1 is comprised of several pre-fabricated components, generally designated by reference characters A, B, C, D. The front junction point (component A) of the axle support 1 is shown on an enlarged scale in FIG. 2 and includes the front side tube 4, the outer front tube 9 and a front transverse control arm 15 in the form of a sheet steel structure. The individual parts, front side tube 4, outer front tube 9 and front transverse control arm 15, are made of heat-treatable steel and welded together. Subsequently, the component A is tempered or heat-treated in a continuous furnace, followed by quenching and hardening of the component A. Of course, heating may also be realized inductively with subsequent quenching, e.g. by means of a water shower.

The thus heat-treated component A is then joined with the non-heat treated components B and C, whereby component B is comprised of the front central tube 8 and the component C is comprised of the rear side tubes 5. The component D includes the rear cross member 7 with attached parts, as mentioned above. The components A, B, and C are so configured as to complement one another to allow interlocking engagement in a connection zone 16 in overlapping fashion and subsequent welding thereof. Of course, butt-welding may be conceivable as well.

The high-strength component A of the axle support 1 can have a yield strength Rₛ in the range of about 850 MPa to 900 MPa and can be united with the other components B, C, D, which can be made of normal high-grade steel or constructional steel.

While the invention has been illustrated and described as embodied in a structural chassis or body part for a motor vehicle, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and their equivalents:

What is claimed is:

1. A structural chassis or body part, in particular axle support, comprising at least two steel components having different strengths, with one of the components being heat-treated.

2. The structural part of claim 1, wherein the other one of the components is non-heat treated.

3. The structural part of claim 1, wherein the heat-treated component has a yield strength between 850 MPa and 950 MPa.

4. The structural part of claim 1, wherein the heat-treated component is made of two parts.

5. The structural part of claim 1, wherein the components are connected together through a jointing process.

6. The structural part of claim 5, wherein the components are connected together through welding.

7. The structural part of claim 1, wherein the components interlock in a connection zone and are jointed together.
